(19) United States
(12) Patent Application Publication
(10) Pub. No.: US 2018/0276329 A1
(43) Pub. Date: Sep. 27, 2018

(54) COMPONENT POSITION DETECTION METHOD AND INFORMATION PROCESSING APPARATUS

(71) Applicant: FUJITSU LIMITED, Kawasaki-shi (JP)

(72) Inventors: Yoshiaki HIRATSUKA, Ota (JP); Kazunori KASUGA, Yokohama (JP); Tomoyuki NAKAO, Yokohama (JP); Kenji NAGASE, Yokohama (JP)

(73) Assignee: FUJITSU LIMITED, Kawasaki-shi (JP)

(21) Appl. No.: 15/903,987

(22) Filed: Feb. 23, 2018

(30) Foreign Application Priority Data
Mar. 27, 2017 (JP) 2017-061197

(51) Int. Cl. G06F 17/50

(52) U.S. Cl. CPC G06F 17/5081; G06F 2217/02

(57) ABSTRACT

A non-transitory, computer-readable recording medium having stored therein a program for causing a computer to execute a process that includes: setting a starting point and a target component on a circuit of a circuit diagram; tracing lines based on connection relationship of a component located between the starting point and the target component; counting the number of lines between the starting point and the target component; determining positional relationship of components based on the counted number of the lines; and outputting information that the positional relationship is inappropriate when determination result indicates that the positional relationship is inappropriate.

### CROSS-REFERENCE TO RELATED APPLICATION

This application is based upon and claims the benefit of priority of the prior Japanese Patent Application No. 2017-61197, filed on Mar. 27, 2017, the entire contents of which are incorporated herein by reference.

### FIELD

Embodiments discussed herein are related to a component position detection method and an information processing apparatus.

### BACKGROUND

In the development of an electronic device, development works are performed in a stepwise manner in the order of circuit design, packaging design, packaging of components onto the substrate, and inspection and evaluation. In the circuit design, a circuit diagram specifying the connection relationship of components so as to satisfy a demanded function is generated using a computer aided design (CAD) for circuit design. In the packaging design, a packaging diagram indicating an arrangement pattern for packaging a component and a wiring onto a substrate is generated based on the circuit diagram, using a packaging design CAD. In this way, in the development of an electronic device, the connection relationship of components is designed at the stage of the circuit design, and actual arrangement relationship between components is determined at the stage of the packaging design.

Related techniques are disclosed in Japanese Laid-open Patent Publication Nos. 6-119415 and 2014-186705.

In an electronic device, a defect sometimes occurs due to the positional relationship of components. In the development of an electronic device, arrangement of components is verified using a packaging design CAD at the stage of the packaging design to check a defect. Then, when a defect occurs, the circuit is modified in some cases by returning to the stage of the circuit design. Thus, when a circuit is modified by returning to the circuit design, development period is prolonged, development costs increase, and opportunity loss due to delay of commercialization occurs.

### SUMMARY

According to one aspect of the embodiments, it is an object of the embodiments to provide a component position detection program, a component position detection method, and an information processing apparatus, which are capable of properly determining the positional relationship of a packaged component at the stage of the circuit design.

According to an aspect of the embodiments, a non-transitory, computer-readable recording medium having stored therein a program for causing a computer to execute a process that includes: setting a starting point and a target component on a circuit of a circuit diagram; tracing lines based on connection relationship of a component located between the starting point and the target component; counting the number of lines between the starting point and the target component; determining positional relationship of components based on the counted number of the lines; and outputting information that the positional relationship is inappropriate when determination result indicates that the positional relationship is inappropriate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing apparatus;

FIG. 2 is a diagram illustrating an example of a circuit diagram according to a first embodiment;

FIG. 3A is a diagram illustrating an example of a circuit diagram according to the first embodiment;

FIG. 3B is a diagram illustrating an example of a packaging diagram according to the first embodiment;

FIG. 3C is a diagram illustrating an example of a signal obtained by simulation;

FIG. 4A is a diagram illustrating occurrence of a malfunction;

FIG. 4B is a diagram illustrating a noise passage;

FIG. 5A is a diagram illustrating an example of a modified circuit diagram according to the first embodiment;

FIG. 5B is a diagram illustrating an example of a modified packaging diagram according to the first embodiment;

FIG. 6 is a diagram illustrating another example of a circuit diagram according to the first embodiment;

FIG. 7 is a flowchart illustrating an example of a component position detection processing;

FIG. 8 is a diagram illustrating an example of a circuit diagram according to a second embodiment; and

FIG. 9 illustrates an example of a hardware configuration.

### DESCRIPTION OF EMBODIMENTS

Hereinafter, embodiments of a component position detection program, a component position detection method, and an information processing apparatus disclosed herein are described in detail with reference to the accompanying drawings. The disclosed technique is not limited by the embodiments. The embodiments described below may be combined together as appropriate within a scope not causing inconsistency.

### First Embodiment

[Configuration of Information Processing Apparatus]

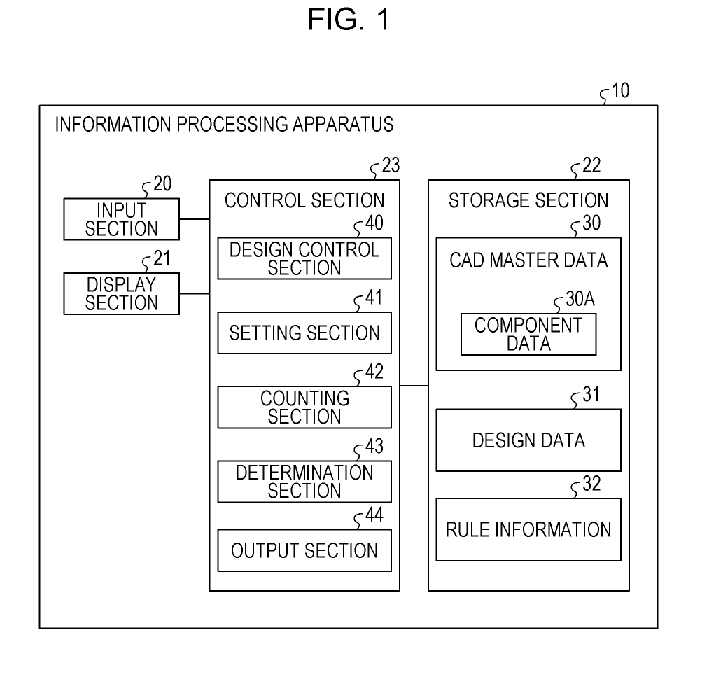

An information processing apparatus 10 according to the first embodiment is described. FIG. 1 is a diagram illustrating a configuration of an information processing apparatus.

The information processing apparatus 10 is an apparatus configured to assist circuit design by a designer, which is a computer such as, for example, a personal computer and a server computer. The information processing apparatus 10 may be packaged as one unit of the computer or as a cloud including a plurality of computers. In the present embodiment, the information processing apparatus 10 is described using one unit of a computer as an example. The information processing apparatus 10 is a computer used by a designer who designs a circuit of an electronic device under development. For example, the information processing apparatus 10 is a design apparatus where a software for the CAD circuit design operates. The information processing apparatus 10 may be a server computer coupled with a terminal device used by the designer via a network in a manner enabling to communicate with each other, and may be configured to receive various operation information on the circuit design from the terminal device and transmit the processing result to the terminal device. For example, the information processing apparatus 10 may be a server computer configured to provide a CAD service in a cloud.

As illustrated in FIG. 1, the information processing apparatus 10 includes an input section 20, a display section 21, a storage section 22, and a control section 23. In addition to function sections illustrated in FIG. 1, the information processing apparatus 10 may include a variety of function sections of known computers such as, for example, a communication interface.

The input section 20 is an input device through which various information is entered. The input section 20 includes an input device which receives input of the operation, such as a mouse and a keyboard. The input section 20 receives input of various information. For example, the input section 20 receives input of various operations that instruct component arrangement in the circuit diagram, the connection relationship between arranged components, and type of wiring that couples components with each other. The input section 20 receives operation input from the user and inputs operation information indicating the content of the received operation to the control section 23.

The display section 21 is a display device that displays various information. The display section 21 includes a display device such as a liquid crystal display (LCD) and a cathode ray tube (CRT). The display section 21 displays various information. For example, the display section 21 displays various screens including, for example, the circuit diagram and the operation screen.

The storage section 22 is a storage device such as a hard disk, a solid-state drive (SSD), and an optical disk. The storage section 22 may be a semiconductor memory capable of rewriting data, such as a random-access memory (RAM), a flash memory, and a non-volatile static random-access memory (NVSRAM).

The storage section 22 stores an operating system (OS) and various programs executed by the control section 23. For example, the storage section 22 stores a program of a CAD software for circuit design and a program executing component position detection processing described later. Further, the storage section 22 stores various data used in programs executed by the control section 23. For example, the storage section 22 stores CAD master data 30, design data 31, and rule information 32.

The CAD master data 30 is data storing various information used in operations of the circuit design CAD. The CAD master data 30 includes component data 30A.

The component data 30A stores various information related to components usable in the circuit design. For example, the component data 30A stores information such as the component type and the type of the signal outputted from a terminal of the component.

The design data 31 is data storing a circuit designed with the circuit design CAD. The design data 31 stores information of the designed circuit diagram. For example, the design data 31 stores information related to the component arrangement and the connection relationship between components.

The rule information 32 is data storing information related to rules used to determine a component in an inappropriate position relationship. In the embodiment, lines indicating wirings in the circuit diagram are traced to determine the positional relationship between components by the number of lines to a connecting point where a component is connected

The rule information 32 stores the condition of the number of lines representing the positional relationship causing a defect, for each of component combinations causing the defect.

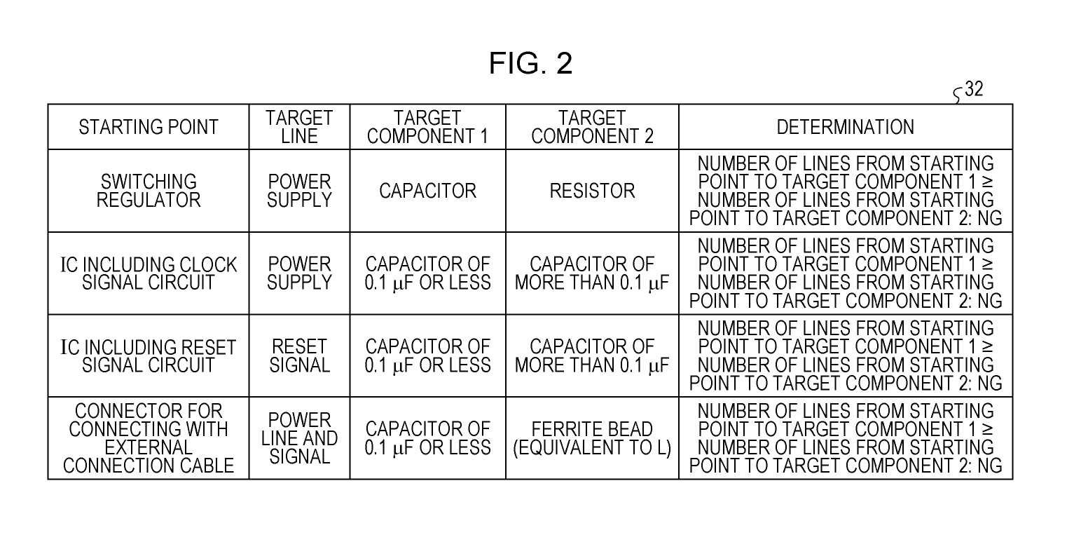

FIG. 2 is a diagram illustrating an example of the rule information. The rule information 32 includes fields of “starting point”, “target line”, “target component 1”, “target component 2”, and “determination”. The rule information 32 illustrated in FIG. 2 is an example, and other fields may be added thereto.

The field of the starting point is an area in which a starting point to count the number of lines is stored. The starting point may be designated out of circuit components, with a connecting point between a circuit component and a wiring, or with a connector. The field of starting point stores, for example, information designating the circuit component as a starting point. The field of the target line is an area storing the type of the target line on which the positional relationship between components is determined. The “power supply” of the target line indicates that a line of the power supply is a line to be determined. The “reset signal” indicates that a line in which a reset signal flows is a line to be determined. The “signal” indicates that a line in which a signal flows is a line to be determined.

The field of the target component 1 is an area storing type of one component on which the positional relationship is determined. The field of the target component 2 is an area storing the type of another component on which the positional relationship is determined. The field of determination condition stores the condition of the positional relationship causing a defect. The field of determination condition stores the condition of NG as the NG positional relationship causing a defect.

For example, a first line illustrated in FIG. 2 indicates that the positional relationship between the capacitor and the resistor is determined when the starting point is the switching regulator, and the target line is the power line. When the number of lines from the starting point to the capacitor the number of lines from the starting point to the resistor, it indicates that the capacitor and the resistor is in a positional relationship causing a defect.

Referring to FIG. 1, the control section 23 is a device that controls the information processing apparatus 10. As a processor, the control section 23 may adopt an electronic circuit such as, for example, a central processing unit (CPU) and a micro processing unit (MPU), and an integrated circuit such as an application specific integrated circuit (ASIC) and a field programmable gate array (FPGA). The control section 23 may include an internal memory for storing programs specifying various processing procedures and control data to execute various processings. The control section 23 functions as a processor when various programs run. For example, the control section 23 includes a design control section 40, a setting section 41, a counting section 42, a determination section 43, and an output section 44. Internal configuration of the control section 23 is not limited to the configuration illustrated in FIG. 1, but may be another configuration suitable for performing a component position detection processing described later.

The design control section 40, which includes operations of a software of the circuit design CAD as a processor, performs various controls related to the circuit design. For example, the design control section 40 performs control of causing the display section 21 to display various information. For example, the design control section 40 causes the display section 21 to display various screens such as the circuit diagram and the operation screen. Also, the design control section 40 receives operations related to the circuit design via the input section 20. For example, the design control section 40 receives input of various operations that instruct the component arrangement into the circuit diagram, the connection relationship between arranged components, and the type of the wiring that couples components. The design control section 40 causes the display section 21 to display the displayed circuit diagram and operation screen by modifying according to a received operation.

The designer carries out an operation related to the circuit design through the input section 20 to generate a circuit diagram. For example, in the development of an electronic device, the designer carries out various operations that instruct the component arrangement into the circuit diagram, the connection relationship between arranged components, and the type of the wiring that couples components to generate a circuit diagram such that functions demanded for the electronic device under development are achieved.

Here, a development flow of the electronic device is described. As described above, in the development of electronic devices, development works are performed in a stepwise manner in the order of the circuit design, the packaging design, the packaging of components onto the substrate, and the inspection and evaluation. In the circuit design, a circuit diagram specifying the connection relationship between components so as to implement demanded functions is generated.

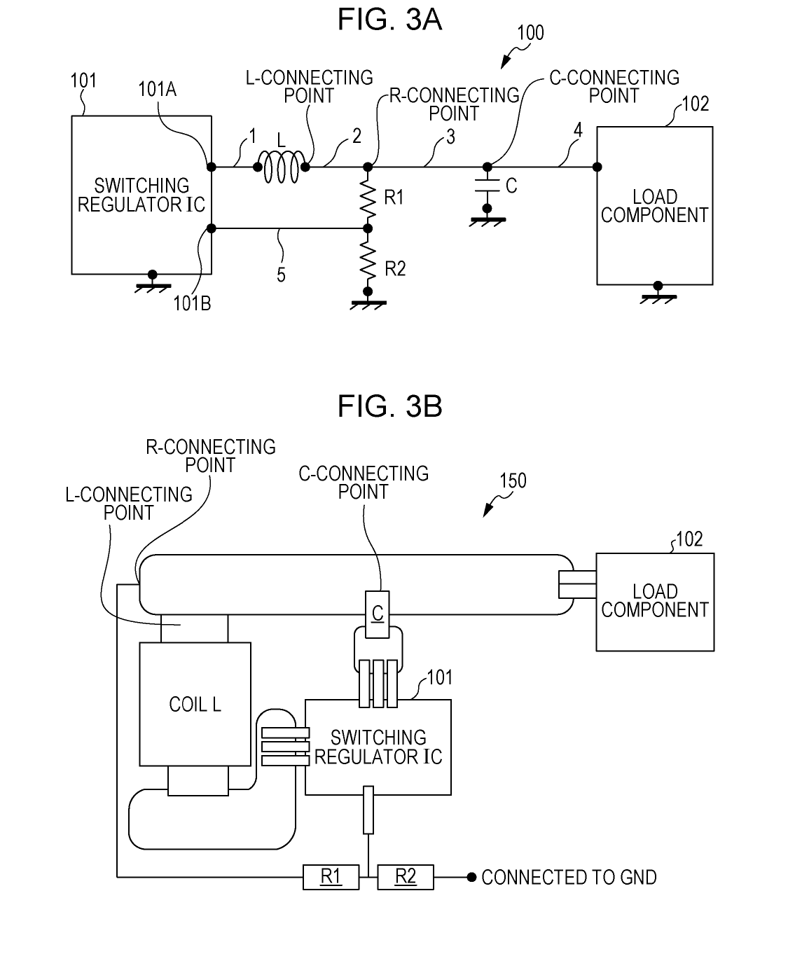

FIG. 3A is a diagram illustrating an example of a circuit diagram according to the first embodiment. The circuit diagram depicts components constituting the circuit and lines indicating wirings that connect the components with each other. The example of FIG. 3A illustrates a circuit diagram 100 of a power supply circuit that supplies power of a predetermined voltage to a load component 102. In the circuit diagram 100, a grounded switching regulator integrated circuit (IC) 101 is arranged. The switching regulator IC 101 has a terminal 101A that outputs a pulse signal as another power supply. The terminal 101A is connected with one end of a coil L via a line 1. Another end of the coil L is connected with one end of a resistor R1 via a line 2. The one end of the resistor R1 is further connected with one end of a capacitor C via a line 3. Another end of the capacitor C is grounded. One end of the capacitor C is further connected with a load component 102 via a line 4. Another end of the resistor R1 is connected with one end of a resistor R2. Another end of the resistor R2 is grounded. A connecting point between the resistor R1 and the resistor R2 is connected with a terminal 10113 of the switching regulator IC 101 via a line 5. A connecting point between another end of the coil L and the line 2 is an L-connecting point. A connecting point between one end of the resistor R1 and the line 2 is an R-connecting point. A connecting point between one end of the capacitor C and the line 3 is a C-connecting point.

The circuit diagram 100 is designed such that a pulse signal outputted through the terminal 101A of the switching regulator IC 101 is smoothed by the coil L and the capacitor C to supply power of a fixed voltage to the load component 102. The circuit diagram 100 is designed such that voltage at another end of the coil L is divided by the resistor R1 and the resistor R2 and fed back to the terminal 101B. Then, the circuit diagram 100 is designed to supply power of a fixed voltage to the load component 102 by controlling pulse width modulation (PWM) of the pulse signal outputted by the switching regulator IC 101 through the terminal 101A depending on the voltage of the terminal 101B.

In the stage of the packaging design, a packaging diagram is generated using a packaging design CAD. For example, an operator of the packaging design arranges components and lines of the circuit diagram on a substrate in an order providing a higher arrangement efficiency to reflect the circuit diagram on the packaging diagram. In general, the operator of the packaging design arranges a component connected to a line of the circuit diagram at a location closer in the left-to-right direction or in the top-to-bottom direction to reflect the circuit diagram on the packaging diagram.

FIG. 3B is a diagram illustrating an example of a packaging diagram according to the first embodiment. The packaging diagram 150 illustrated in FIG. 3B is an example of an arrangement pattern on which the circuit diagram 100 illustrated in FIG. 3A is reflected. In the packaging diagram 150, identical numerals or codes are assigned to parts corresponding to the switching regulator IC 101, the load component 102, the coil L, the capacitor C, the resistor R1, the resistor R2, the L-connecting point, the R-connecting point, and the C-connecting point of the circuit diagram 100 illustrated in FIG. 3A.

Meanwhile, multi-functionality of electronic devices is in progress, and various power supplies for driving the IC are generated. However, depending on the arrangement position of components, there is a concern that malfunction of a device or electromagnetic noise emitted from an electronic device may affect other electronic devices.

In the development of an electronic device, the connection relationship between components is designed at the stage of the circuit design, and arrangement relationship between actual components is determined at the stage of the packaging design. For this reason, in the development of a conventional electronic device, the arrangement relationship between components is verified, and a defect such as occurrence of the electromagnetic noise is checked at the stage of the packaging design.

In the packaging design, for example, a defect such as occurrence of an electromagnetic noise is checked in the packaging diagram 150. For example, in checking at the stage of the packaging design, a defect such as occurrence of an electromagnetic noise is checked by simulating a calculated state in which a signal is flown into a circuit of the packaging diagram 150 in a pseudo manner.

FIG. 3C is a diagram illustrating an example of a signal obtained by simulation. FIG. 3C illustrates voltage waveform of a signal flowing through connecting points R and C. In the packaging diagram 150, the C-connecting point that smoothes output voltage is closer to the coil L than the R-connecting point that monitors the voltage level. For this reason, as illustrated in FIG. 3C, fluctuation of the voltage level of the voltage waveform of signal flowing through the R-connecting point is large and increases fluctuation of the feedback, which may cause a malfunction. Also, in the packaging diagram 150, a passage in which a signal with large fluctuation flows is large, and increases a noise passage in which noise occurs, and also noise radiation.

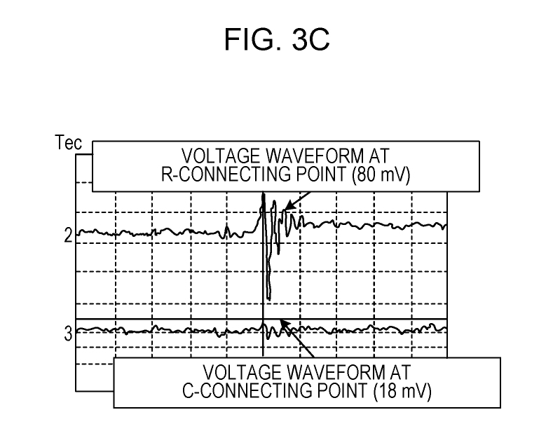

FIG. 4A is a diagram illustrating occurrence of a malfunction. When fluctuation of the voltage level of the voltage waveform of signal flowing through the R-connecting point is large, fluctuation of the feedback signal flowing through the line 5 also becomes large, and this may cause a malfunction.

FIG. 4B is a diagram illustrating a noise passage. In the packaging diagram 150, a passage up to the C-connecting point where noise is attenuated is farther. Thus, the noise passage where noise occurs becomes larger and noise radiation increases.

In the development of an electronic device, when a defect is found at the stage of the packaging design, the circuit may be modified by returning to the circuit design. However, when the circuit is modified by returning to the circuit design, development period is prolonged, development costs increase, and opportunity loss due to delay of commercialization occurs.

To solve this problem, the information processing apparatus 10 according to the embodiment is configured as below so as to determine at the stage of the circuit design whether the positional relationship between packaged components is appropriate.

Description is given by referring back to FIG. 1. The setting section 41 is configured to perform various settings. For example, the setting section 41 sets a target range and a target component on which the positional relationship is determined in a circuit diagram of the determination target. For example, the setting section 41 sets a starting point and a target component onto a circuit of the circuit diagram. The starting point and the target component may be designated by the designer or may be set automatically. The setting section 41 may set a starting point and a target component designated by the designer as the starting point and the target component.

For example, when a defect is checked by the designer in the circuit design, the setting section 41 sets a target selected by the designer from the circuit diagram as the starting point. For example, when the designer selects a component, a connecting point, and a connector from the circuit diagram in the circuit design, the setting section 41 sets the selected component, the connecting point, and the connector as the starting point. The setting section 41 traces lines in which a signal from a selected starting point flows, and sets components in which the signal from the selected starting point flows, as target components respectively. When a component is arranged or a line is connected half way or at a terminating end of a line in which a signal flows, the setting section 41 may set an output source of the signal flowing in the line as a starting point. Then, the setting section 41 traces lines in which the signal from the starting point flows, and sets components in which the signal from the selected starting point flows, as target components respectively. For example, the setting section 41 identifies, based on the component data 30A, the type of the terminal outputting the signal and the outputted signal for a component selected as the starting point, traces lines in which the signal flows, and sets components in which the signal from the selected starting point flows, as target components respectively. More specifically, the setting section 41 determines a combination of components in which the signal from the starting point flows and the starting point, and sequentially sets a starting point and a target component for each of the combinations.

For example, when checking a designed circuit diagram for a defect, the setting section 41 sequentially selects, for example, a component outputting the signal as a starting point from the circuit diagram. Then, the setting section 41 traces lines in which a signal from a selected starting point flows, and sets components in which the signal from the selected starting point flows, as target components respectively. More specifically, the setting section 41 traces, by changing the starting point sequentially, lines in which the signal from each starting point flows, determines a combination of the starting point and the target component, with a component in which the signal from each starting point flows, as a target component respectively, and sequentially sets the starting point and the target component for each of the combinations.

The counting section 42 traces lines based on the connection relationship of components located between the starting point and the target component for each of selected starting points and target components to count the number of lines. For example, the counting section 42 counts the number of lines from the starting point to the target component, with a line between components, a line between a component and a branching point of a line, a line between branching points, and a line between a branching point and a component as one line.

For example, in the circuit diagram 100 illustrated in FIG. 3A, the R-connecting point and the C-connecting point are branching points where a line branches. The counting section 42 counts the number of lines with a line up to a branching point as one line. For example, when the starting point is the switching regulator IC 101 and the target component is the resistor R1, the counting section 42 counts the number of lines as two with lines 1 and 2 from the switching regulator IC 101 to the resistor R1 as one line respectively. Also, when the starting point is the switching regulator IC 101 and the target component is the capacitor C, the counting section 42 counts the number of lines as three with lines 1, 2 and 3 from the switching regulator IC 101 to the capacitor C as one line respectively. Also, when the starting point is the switching regulator IC 101 and the target component is the load component 102, the counting section 42 counts the number of lines as four with lines 1, 2, 3, and 4 from the switching regulator IC 101 to the load component 102 as one line respectively.

The determination section 43 determines the positional relationship of components based on the counted number of the lines. For example, the determination section 43 determines based on the counted number of the lines whether there is a component in an inappropriate positional relationship. For example, the determination section 43 determines for each of components in which the signal from the starting point flows whether there is a component in an inappropriate positional relationship, by comparing the number of lines of respective components. Here, the number of lines becomes larger as the positional relationship between the component and the starting point along lines is farther. Thus, the positional relationship of components along lines may be compared by comparing the number of lines.

In the embodiment, a rule used to determine a component in an inappropriate positional relationship is stored in rule information 32.

The determination section 43 determines whether there is a component in a positional relationship satisfying the rule stored in the rule information 32. For example, the determination section 43 identifies, for the selected component, the type of the component and the type of the signal outputted from a terminal of the component, based on the component data 30A. Then, determination section 43 compares the number of lines of respective target components on which the number of lines from the starting point is counted, and determines whether there is a component satisfying the rule stored in the rule information 32. For example, in the circuit diagram 100 illustrated in FIG. 3A, the terminal 101A is a power supply line that supplies power to the load component 102, and there are two lines of the resistor R1 relative to the terminal 101A and three lines of the capacitor C. Thus, the terminal 101A corresponds to a first line of the rule information 32. In this case, in the circuit diagram 100, the determination section 43 determines that the capacitor C and the resistor R1 are components in an inappropriate relationship.

The output section 44 is configured to perform various outputs. For example, when the determination section 43 determines that the positional relationship is inappropriate, the output section 44 outputs information that the positional relationship is inappropriate. For example, the output section 44 displays a component in an inappropriate positional relationship in an identifiable manner. For example, the output section 44 highlights the component and lines from the starting point to the component by changing the color and background, and displays an error message. For example, in the circuit diagram 100 illustrated in FIG. 3A, the output section 44 highlights the capacitor C, the resistor R1, the line 1, the line 2, and the line 3, and displays an error message.

This enables the designer to recognize from the displayed content that there is a component in an inappropriate positional relationship. The designer modifies the component in an inappropriate positional relationship.

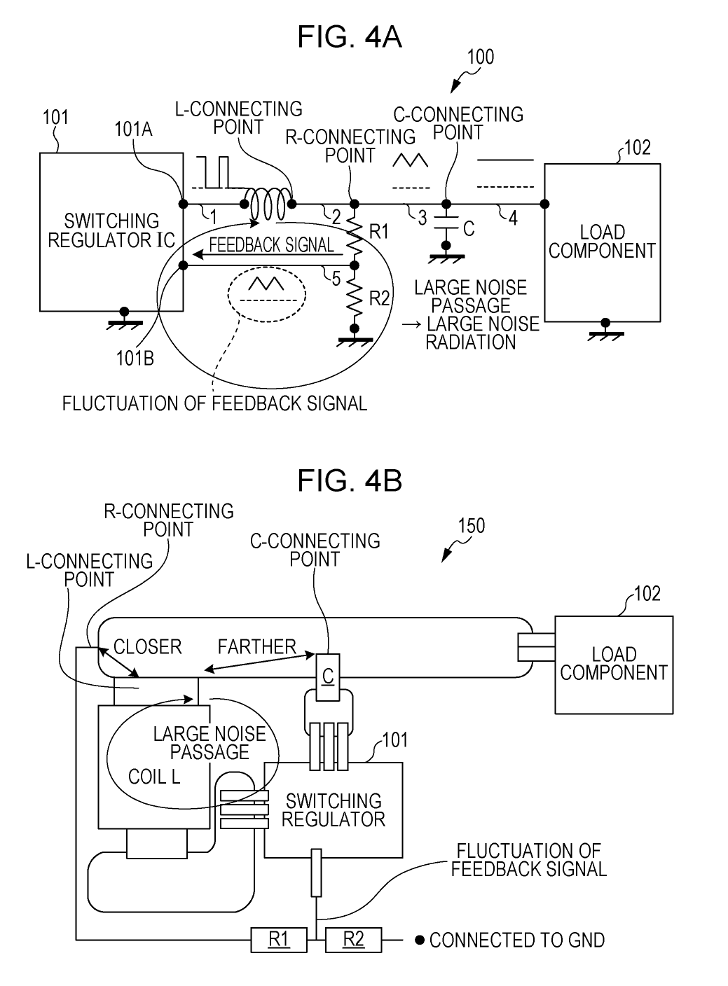

FIG. 5A is a diagram illustrating an example of a modified circuit diagram according to the first embodiment. The circuit diagram 200 indicates a modified positional relationship between the capacitor C and the resistor R1 of the circuit diagram 100 illustrated in FIG. 3A. In the circuit diagram 200, another end of the coil L is connected to one end of the capacitor C via the line 2. One end of the capacitor C is further connected with one end of the resistor R1 via the line 3. One end of the resistor R1 is further connected with a load component 102 via the line 4. More specifically, in the circuit diagram 200, the circuit diagram 100 illustrated in FIG. 3A is modified by replacing positions of the capacitor C and the resistor R1 with each other. This arrangement reduces fluctuation of the voltage of the voltage waveform of signal flowing through the R-connecting point and fluctuation of the feedback in the circuit diagram 200, and thereby suppresses malfunction.

FIG. 5B is a diagram illustrating an example of a modified packaging diagram according to the first embodiment. The packaging diagram 250 illustrated in FIG. 5B is an example of an arrangement pattern on which the circuit diagram 200 illustrated in FIG. 5A is reflected. In the packaging diagram 250, identical numerals or codes are assigned to parts corresponding to the switching regulator IC 101, the load component 102, the coil L, the capacitor C, the resistor R1, the resistor R2, the L-connecting point, the R-connecting point, and the C-connecting point of the circuit diagram 200 illustrated in FIG. 5A. Also, in the packaging diagram 250, a passage in which a signal with large fluctuation is small. This reduces a noise passage in which noise occurs, and thereby reduces noise radiation.

Here, it is conceived, for example, that a component in an inappropriate positional relationship is determined by reading coordinates such as X and Y of the connecting point in the circuit diagram and calculating a distance between the coordinates. However, the distance between coordinates on the circuit diagram may cause a recognition error.

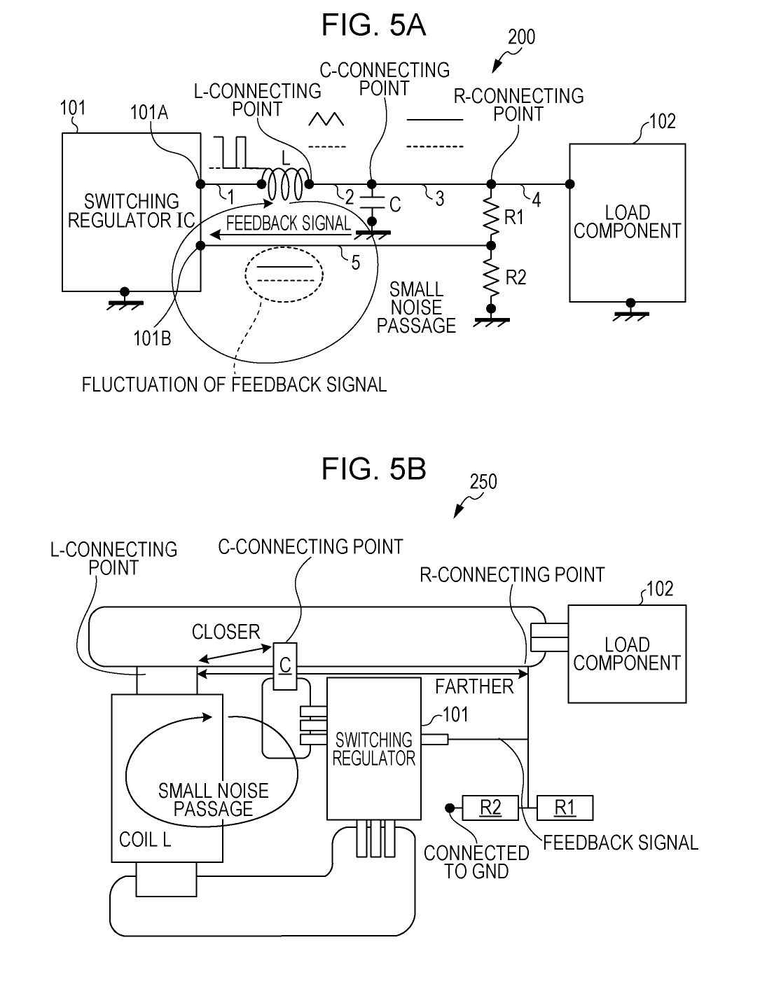

FIG. 6 is a diagram illustrating an example of a circuit diagram according to the first embodiment. The circuit diagram 300 is a favorable circuit diagram free from a component in an inappropriate positional relationship. The circuit diagram 300 is designed such that a pulse signal outputted through a terminal SW1 of the switching regulator IC 101 is smoothed by a coil L7 and a capacitor C104 to supply power of a fixed voltage. The circuit diagram 300 is designed such that voltage to be supplied is divided by a resistor R29, a resistor R30, and a resistor R31 and then fed back to a terminal VFB. A connecting point of the resistor R29 is the R-connecting point. A connecting point of the capacitor C104 is the C-connecting point. The circuit diagram 300 is designed such that a distance Lr along a line from the terminal SW 1 of the switching regulator IC 101 to the R-connecting point is larger and electrically farther than a distance Lc along a line from the terminal SW1 of the switching regulator IC 101 to the C-connecting point.

When calculating a distance between coordinates on the circuit diagram 300, a distance from the terminal SW1 of the switching regulator IC 101 to the resistor R29 is calculated as a distance Lrx. Then, since the distance Lrx is shorter than the distance Lc, the resistor R1 may be determined by error as a component in an inappropriate positional relationship as the distance to the resistor R1 is shorter than the distance to the capacitor C.

Meanwhile, the information processing apparatus 10 according to the present embodiment may determine a distance via an electrical passage but not a distance between coordinates, by tracing lines based on the connection relationship of components located between the starting point and the target component and then counting the number of lines. Components in the passage of the circuit diagram are sequentially reflected on the packaging diagram along the passage. For example, an operator of the packaging design sequentially arranges a component connected to a line of the circuit diagram at a location closer in the left-to-right direction or in the top-to-bottom direction to reflect the circuit diagram on the packaging diagram. Thus, the arrangement relationship of components identified based on the distance via the electrical passage in the circuit diagram is reflected on the packaging diagram. This enables the information processing apparatus 10 to determine the positional relationship of packaged components by determining the distance via the electrical passage of the circuit diagram and then properly determine a packaged component which is in an inappropriate positional relationship.

[Flow of Processing]

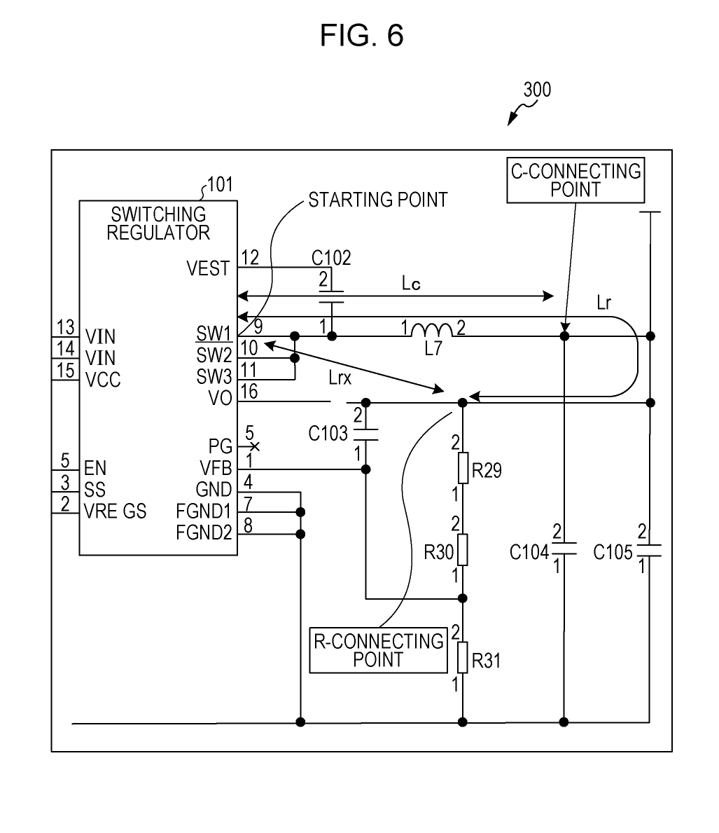

Next, a flow of a component position detection processing in which the information processing apparatus 10 detects, based on the circuit diagram, a component in a positional relationship causing a defect is described. FIG. 7 is a flowchart illustrating an example of the component position detection processing. The component position detection processing is implemented in a predetermined timing, for example, a timing when the designer makes a selection from the circuit diagram.

The setting section 41 sets a target which the designer selects from the circuit diagram as a starting point, collects data relative to the component from the component data 30A, and identifies the terminal outputting the signal and the type of outputted signal for the component selected as the starting point (step S10). The setting section 41 traces lines in which a signal flows, and sets respective components in which the signal from the selected starting point flows as target components (step S11).

The counting section 42 traces lines based on the connection relationship of components located between the starting point and the target component for each of selected starting points and target components to count the number of lines (step S12).

The determination section 43 reads a rule stored in the rule information 32 (step S13). The determination section 43 determines whether there is a component in a positional relationship satisfying the rule stored in the rule information 32 (step S14). When determination result indicates that there is no component in the positional relationship satisfying the rule (step S14: No), the determination section 43 ends the processing.

On the other hand, when determination result indicates that there is a component in the positional relationship satisfying the rule (step S14: Yes), the output section 44 outputs information that the positional relationship is inappropriate (step S15), and ends the processing. This enables the designer to modify the component in an inappropriate positional relationship. The circuit diagram may have a configuration which performs the component position detection processing again after a component is modified.

Thus, the information processing apparatus 10 according to the present embodiment sets a starting point and a target component on a circuit of the circuit diagram. The information processing apparatus 10 traces lines based on the connection relationship of components located between the starting point and the target component to count the number of lines. The information processing apparatus 10 determines the positional relationship of the component based on the counted number of the lines. When the determination result indicates that the positional relationship is inappropriate, the information processing apparatus 10 outputs information that the positional relationship is inappropriate. Thus, the information processing apparatus 10 may determine at the stage of the circuit design whether the positional relationship of the packaged component is appropriate.

The information processing apparatus 10 according to the present embodiment sequentially sets components in which the signal from the starting point flows on the circuit of the circuit diagram. The information processing apparatus 10 counts the number of lines from the starting point to the concerned target component for each of the target components. The information processing apparatus 10 determines the positional relationship of components by comparing the number of lines of respective components set as the target component. Thus, the information processing apparatus 10 may determine for each of components in which the signal from the starting point flows whether the positional relationship of the packaged component is appropriate.

The information processing apparatus 10 according to the present embodiment counts the number of lines from the starting point to the target component, with a line between components, a line between a component and a branching point of a line, a line between branching points, and a line between a branching point and a component, as one line. This enables the information processing apparatus 10 to determine the distance via the electrical passage based on the number of lines and thereby properly determine a component in an inappropriate positional relationship.

For a second component which is in an inappropriate positional relationship when the distance from the starting point is shorter than a first component, the information processing apparatus 10 according to the present embodiment determines that the positional relationship is inappropriate even when the number of lines of the first component and the number of lines of the second component are equal to each other. Thus, the information processing apparatus 10 may suppress occurrence of a defect based on the positional relationship between the first component and the second component.

### Second Embodiment

In the first embodiment, the number of lines is counted with a line between components, a line between a component and a branching point of a line, a line between branching points, and a line between a branching point and a component, as one line. In the second embodiment, another method of counting the number of lines is described.

Since the information processing apparatus 10 according to the second embodiment has a configuration similar with the information processing apparatus 10 according to the first embodiment illustrated in FIG. 1, description of identical parts is omitted, and description is mainly focused on different parts.

Here, there is a circuit design CAD which arranges points at equal intervals in a two-dimensional manner, and a circuit indicated by the connection relationship of components in conformity to the points, on the screen of the circuit diagram.

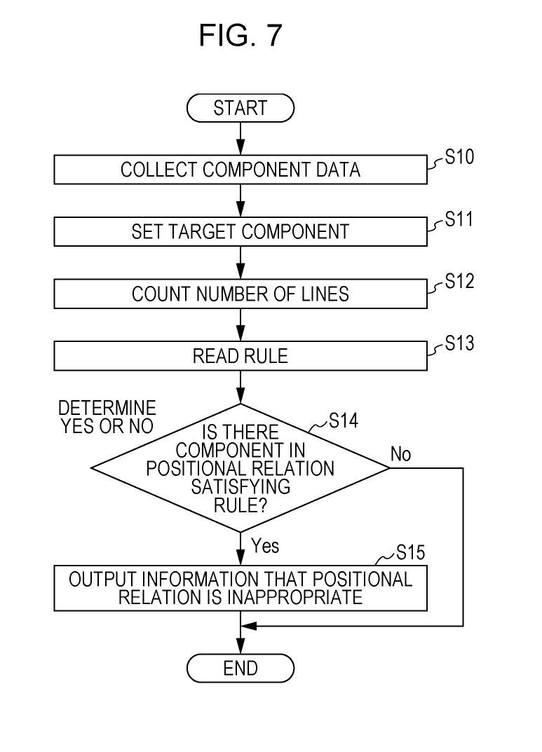

FIG. 8 is a diagram illustrating an example of a circuit diagram according to the second embodiment. In FIG. 8, the circuit diagram 100 illustrated in FIG. 3A is illustrated. In the circuit diagram 100, points are arranged at equal intervals in a two-dimensional manner, and a circuit indicated by the connection relationship of components in conformity to the points is arranged.

The counting section 42 traces lines based on the connection relationship of components located between the starting point and the target component for each of selected starting points and target components to count the number of lines from the starting point to the target component, with lines connecting points with each other as one line. For example, the counting section 42 counts the number of lines from the starting point to the target component, with lines connecting points with each other as one line. For example, when the starting point is the switching regulator IC 101 and the target component is the resistor R1, the counting section 42 counts the number of lines as two, with the line 1 from the switching regulator IC 101 to the resistor R1 as one line, and the line 2 as one line. Also, the counting section 42 counts the number of lines as four, with the line 1 from the switching regulator IC 101 to the capacitor C as one line, the line 2 as one line, and the line 3 as two lines. Also, the counting section 42 counts the number of lines as eight, with the line 1 from the switching regulator IC 101 to the load component 102 as one line, the line 2 as one line, the line 3 as two lines, and the line 4 as four lines.

The determination section 43 determines whether there is a component in a positional relationship satisfying the rule stored in the rule information 32. For example, in the circuit diagram 100 illustrated in FIG. 8, the terminal 101A is a power supply line that supplies power to the load component 102, the resistor R1 has two lines relative to the terminal 101A, and the capacitor C has four lines relative to the terminal 101A. Thus, the terminal 101A corresponds to a first line of the rule information 32. In this case, in the circuit diagram 100, the determination section 43 determines that the capacitor C and the resistor R1 are components in an inappropriate positional relationship.

Thus, the information processing apparatus 10 may determine a component in an inappropriate positional relationship in the same manner by counting the number of lines from the starting point to the target component, with a line connecting points with each other as one line.

Thus, when points are arranged at equal intervals in a two-dimensional manner on the circuit diagram and a circuit indicated by the connection relationship of components in conformity to the points is arranged thereon, the information processing apparatus 10 counts the number of lines from the starting point to the target component, with a line connecting points with each other as one line. This enables the information processing apparatus 10 to determine a positional relationship close to a packaged position based on the number of lines.

### Third Embodiment

In the above, embodiments of the present disclosure are described. However, the present disclosure may be implemented in various different modes other than the embodiments described above.

For example, in the above embodiments, the rule information 32 stores the condition of the number of lines representing the positional relationship causing a defect, for each combination of components causing the defect. In the above description, the determination section 43 determines that a defect occurs when the condition of the rule information 32 is satisfied. However, it is not limited thereto. For example, the rule information 32 is caused to store the condition of the number of lines representing the positional relationship not causing a defect, for each combination of components causing a defect. When the condition of the rule information 32 is not satisfied, the determination section 43 may determine that a defect occurs.

Out of processings described in the present embodiment, a whole or a part of processings which are described as being automatically performed may be performed manually. Alternatively, a whole or a part of processings which are described as being performed manually may be automatically performed by a known method. In addition, information including processing procedures, control procedures, specific name, and various data and parameters illustrated in the above documents and drawings may be modified as desired unless otherwise specified.

Illustrated components of respective devices are function conceptual and may not be physically configured in the same manner as illustrated. More specifically, specific modes of dispersion and integration of devices are not limited to the illustrated one. In other words, a whole or a part of a device may be configured by functionally or physically dispersing or integrating in a desired section according to, for example, various loads and operational circumstances. For example, functions of the information processing apparatus 10 may be configured by dispersing and packaging into a plurality of servers. Further, a whole or a part of processing functions performed by respective devices may be implemented by programs analyzed and executed by a CPU and a concerned CPU or as a hardware by a wired logic.

[System]

In the above, embodiments according to the disclosed system are described. Hereinafter, an example of a hardware configuration of the information processing apparatus 10 in respective embodiments is described. A whole or a part of various processing functions performed by respective devices may be performed on a CPU (or a microcomputer such as a MPU and a micro controller unit (MCU)). It is obvious that a whole or any part of various processing functions may be implemented on programs analyzed and executed by a CPU (or a microcomputer such as a MPU and a MCU) or on a hardware by a wired logic. Various processings described in the above embodiments may be implemented by executing programs prepared in advance using a computer. Hereinafter, an example of a computer which executes programs including the same functions as in the above embodiments is described as an example of the hardware configuration.

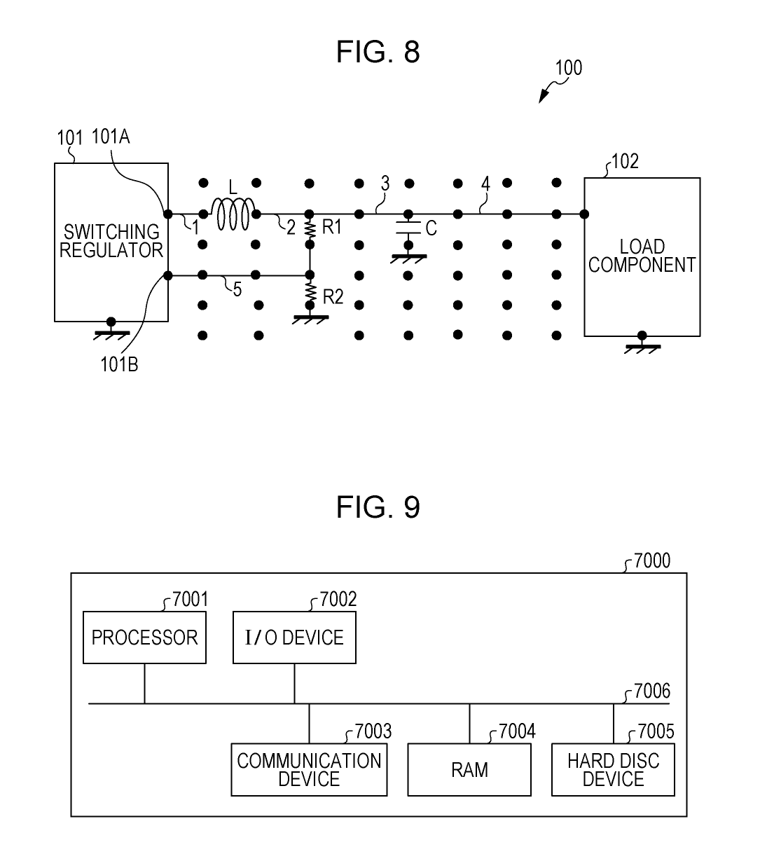

FIG. 9 illustrates an example of a hardware configuration. The information processing apparatus 10 may be implemented by a hardware configuration similar with a computer 7000 illustrated in FIG. 9. As illustrated in FIG. 9, the computer 7000 includes a processor 7001 that executes various arithmetic processings, an I/O device 7002, and a communication device 7003. The computer 7000 also includes a RAM 7004 that temporarily stores various information, and a hard disk device 7005. The devices 7001 to 7005 are coupled with a bus 7006.

The hard disk device 7005 stores a component position detection program including the similar functions as the setting section 41, the counting section 42, the determination section 43, and the output section 44 illustrated in the above embodiments. The hard disk device 7005 stores various data for implementing the component position detection program. For example, the hard disk device 7005 stores the rule information 32.

The processor 7001 reads and develops programs stored in the hard disk device 7005 onto the RAM 7004 to execute various processings. The programs may cause the computer 7000 to function as the setting section 41, the counting section 42, the determination section 43, and the output section 44 illustrated in the above embodiments. Each of the above programs is not requested to be stored in the hard disk device 7005. For example, the computer 7000 may read and execute programs stored in a recording medium readable by the computer 7000.

The “component” described above may include a resistor, a coil, an inductor, a capacitor, a diode, a switch, a transistor, an actuator, a coupler, an integrated circuit, a sensor, a filter, ferrite beads, a wire material, a connector, a relay, an oscillator, a delay device, a terminal, and a substrate, whatever be the electronic component. The “target component” described above may include a resistor, a coil, an inductor, a capacitor, a diode, a switch, a transistor, an actuator, a coupler, an integrated circuit, a sensor, a filter, ferrite beads, a wire material, a connector, a relay, an oscillator, a delay device, a terminal, and a substrate, whatever be the electronic component.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process, the process comprising:
setting a starting point and a target component on a circuit of a circuit diagram;
tracing lines based on connection relationship of a component located between the starting point and the target component;
counting the number of lines between the starting point and the target component;
determining positional relationship of components based on the counted number of the lines; and
outputting information that the positional relationship is inappropriate when determination result indicates that the positional relationship is inappropriate.

2. The non-transitory, computer-readable recording medium according to claim 1, wherein
after setting the starting point and the target component, the setting sequentially sets a component where a signal from the starting point flows as the target component on the circuit of the circuit diagram,
the counting counts the number of lines from the starting point to the target component for each target component, and
the determining determines the positional relationship of components by comparing the numbers of lines of respective components set as the target components.

3. The non-transitory, computer-readable recording medium according to claim 1, wherein the counting counts the number of lines from the starting point to the target component, with each of a line between components, a line between a component and a branching point of a line, a line between branching points, and a line between a branching point and a component, being counted as one line.

4. The non-transitory, computer-readable recording medium according to claim 1, wherein
in the circuit diagram, points are arranged at equal intervals in a two-dimensional manner, and a circuit indicated by the connection relationship of components in conformity to the points, and
the counting processing counts the number of lines from the starting point to the target component with a line connecting the points with each other being counted as one line.

5. The non-transitory, computer-readable recording medium according to claim 1, wherein for a second component which is in inappropriate positional relationship when a distance from the starting point is shorter than a first component, the determining determines that the positional relationship is inappropriate even when the number of lines of the first component and the number of lines of the second component are equal to each other.

6. A detection method comprising:
setting, using a computer, a starting point and a target component onto a circuit of a circuit diagram;
tracing, using the computer, lines based on connection relationship of a component located between the starting point and the target component;
counting, using the computer, the number of lines between the starting point and the target component;
determining, using the computer, positional relationship of the component based on the counted number of the lines; and
outputting information that the positional relationship is inappropriate when determination result indicates that the positional relationship is inappropriate.

7. An information processing apparatus comprising:
a memory;
a processor coupled to the memory and configured to:
set a starting point and a target component onto a circuit of a circuit diagram;
trace lines based on connection relationship of a component located between the starting point and the target component;
count, using the computer, the number of lines between the starting point and the target component;
determine positional relationship of the component based on the counted number of the lines; and
output information that the positional relationship is inappropriate when determination result indicates that the positional relationship is inappropriate.

8. A computer-implemented method of circuit design comprising:
establishing a starting point within the circuit diagram including a plurality of components;
setting one of the plurality of components as a target component;
tracing lines from the starting point to the set target component;
counting the number of lines between the starting point and the target component;
determining a positional relationship of the target component based on the counted number of lines; and
outputting a result indicating appropriateness of the determined positional relationship of the target component based on rule information for the target component and the counted number of lines.

9. The method according to claim 8, further comprising:
collecting component data of a plurality of components included within a circuit diagram, the component data including component type, component signals input or output from components.

10. The method according to claim 9, further comprising:
storing the collected component data in a memory along with the rule information, the rule information stores a condition of a number of lines representing the positional relationship causing a defect, for each of component combinations causing the defect.

11. The method according to claim 8, wherein the result indicating further comprising:
comparing the counted number of lines with a threshold number within the rule information for the target component,
wherein the result indicating appropriateness indicates the positional relationship of the target component in inappropriate when the counted number of lines is greater than the threshold number.

12. The method according to claim 8, wherein the rule information includes the starting point, line characteristics for the plurality of components, a plurality of threshold numbers for different combinations of the plurality of components
